(19) United States
(12) Patent Application Publication
(10) Pub. No.: US 2024/0074634 A1
(43) Pub. Date: Mar. 7, 2024

(54) Docking Trash Can for Automated Robotic Vacuum System and Method

(71) Applicant: Terry G. Jones, Austin, TX (US)

(72) Inventors: Terry G. Jones, Austin, TX (US); Richard Rood, Austin, TX (US)

(73) Assignee: EyeVac, LLC, Austin, TX (US)

(21) Appl. No.: 18/268,503

(22) PCT Filed: Dec. 20, 2021
(86) PCT No.: PCT/US2021/064275

§ 371 Date: Jun. 20, 2023

Related U.S. Application Data
(60) Provisional application No. 63/205,528, filed on Dec. 22, 2020.

(51) Int. Cl. A47L 11/24; B65F 1/04; B65F 1/16

(52) U.S. Cl. CPC A47L 11/24; B65F 1/04; B65F 1/1646; A47L 2201/022; A47L 2201/024

(57) ABSTRACT

A system includes a trash can combined as a unit with a robotic vacuum docking station. The trash can has a lid that is opened to deposit or empty trash in the trash can and otherwise closed to contain the trash. The docking station includes an inlet for receiving a robotic vacuum. The system can include a vacuum motor for carrying vacuumed debris from the robotic vacuum to a bin. The bin can be a canister segregated from the trash can bin or can be the trash can bin itself. The docking station can charge the robotic vacuum.

### TECHNICAL FIELD

The invention generally relates to cleaning systems for home environment, and more particularly relates to a docking trash can for a robotic vacuum that self-empties the vacuum collector, charges the vacuum, and provides a trash disposal can.

### BACKGROUND

Robotic vacuums are popular. These robotic vacuums are battery powered and travel in programmed paths to vacuum rooms and areas. Robotic vacuums have typically been emptied manually. The robotic vacuums include a canister collector that captures vacuumed debris. The vacuumed debris in the collector is emptied by manually removing the collector from engagement with the robotic vacuum and dumping the contents.

Docking stations for robotic vacuums typically receive a robotic vacuum in an inlet charging station and charge the robotic vacuum when residing in the inlet charging station. The docking stations, therefore, serve primarily for charging the robot. The robotic vacuum travels to the inlet of the station, docks in the station with connection to charging contacts, and then can travel from the station and continue vacuuming operations.

Certain attempts have been made to auto-empty a dustbin of a robotic vacuum collector at the docking station. In these instances, the docking station has included a dedicated bin that can retain dust from the robotic vacuum for a limited period of time, such as about a month. The dedicated bin is filled with dust from the dustbin of the robotic vacuum when docked.

Docking stations for robotic vacuums have necessarily occupied some amount of space in a room. Many rooms in which a docking station may be located, such as a kitchen, contain other equipment, facilities, furniture and the like. A trash can, which typically has a fair-sized footprint and may extend vertically some extent, can similarly occupy fairly significant space in a kitchen or other room. Trash cans are typically manually emptied and can enclose substantial volume of trash contents.

It would, therefore, be a significant improvement in the art and technology to provide a robotic vacuum docking station that is integrated as a unit with a trash can. It would further be a significant improvement to automatedly empty vacuumed debris from the robotic vacuum to the trash can. It would also be an improvement to provide space savings in a cleaning environment.

### SUMMARY

An embodiment of the invention is a system. The system includes a trash can and a robotic vacuum docking station connected to the trash can.

Another embodiment of the invention is a system that includes a trash can with an upper lip, a hinge connected to the upper lip of the trash can, a lid connected to the hinge for enclosing the trash can when the lid is closed on the hinge, an inlet connected to the trash can for receiving a robotic vacuum, and a docking element of the inlet for contacting the robotic vacuum received in the inlet.

Yet another embodiment of the invention is a system. The system includes a trash can, a robotic vacuum docking station connected to the trash can, and a vacuum of the trash can for retrieving vacuumed debris from the robotic vacuum and emptying the vacuumed debris into the trash can.

Another embodiment of the invention is a system including a trash can with an upper lip, a hinge connected to the upper lip of the trash can, a lid connected to the hinge for enclosing the trash can when the lid is closed on the hinge, an inlet connected to the trash can for receiving a robotic vacuum, a docking element of the inlet for contacting the robotic vacuum received in the inlet, a suction inlet of the inlet, a vacuum motor connected to the suction inlet, a duct connected to the vacuum motor, and an outlet connected to the duct, the outlet dispenses vacuumed debris collected by the robotic vacuum into the trash can.

Yet another embodiment of the invention is a system that includes a trash can, a robotic vacuum docking station connected to the trash can, and a vacuum communicatively connected to a collected debris accessway of the robotic vacuum.

Another embodiment of the invention is a method that includes receiving a robotic vacuum in a combined docking station and trash can and charging the robotic vacuum from receiving.

Yet another embodiment of the invention is a method of manufacture. The method of manufacture includes providing a trash can and connecting a robotic vacuum docking station to the trash can.

### BRIEF DESCRIPTION OF THE DRAWINGS

The present invention is illustrated by way of example and not limitation in the accompanying figures, in which like references indicate similar elements, and in which:

FIG. 1 illustrates a front and top perspective view of a system of a unitized combined trash can and robotic vacuum docking station, according to certain embodiments of the invention;

FIG. 2 illustrates a front and top perspective view of an opened lid of the trash can of the unitized combined trash can and docking station of the system of FIG. 1, according to certain embodiments of the invention;

FIG. 3 illustrates a right side and top perspective view of a duct of the unitized combined trash can and docking station of the system of FIGS. 1 and 2, according to certain embodiments of the invention;

FIG. 4 illustrates a right side and tope perspective view of the unitized combined trash can and docking station and a robotic vacuum in transit to an inlet of the system of FIGS. 1-3, according to certain embodiments of the invention;

FIG. 5 illustrates a right side vertical cross-section view of a unitized combined trash can and docking station, with a vacuum motor unloader of collected debris from a robotic vacuum (not shown), according to certain embodiments of the invention;

FIG. 6 illustrates a right side vertical cross-section view of another unitized combined trash can and docking station, with a vacuum motor unloader of collected debris from a robotic vacuum (not shown), according to certain embodiments of the invention; and

FIG. 7 illustrates a method of operation of a unitized combined trash can and docking station, according to certain embodiments of the invention.

### DETAILED DESCRIPTION

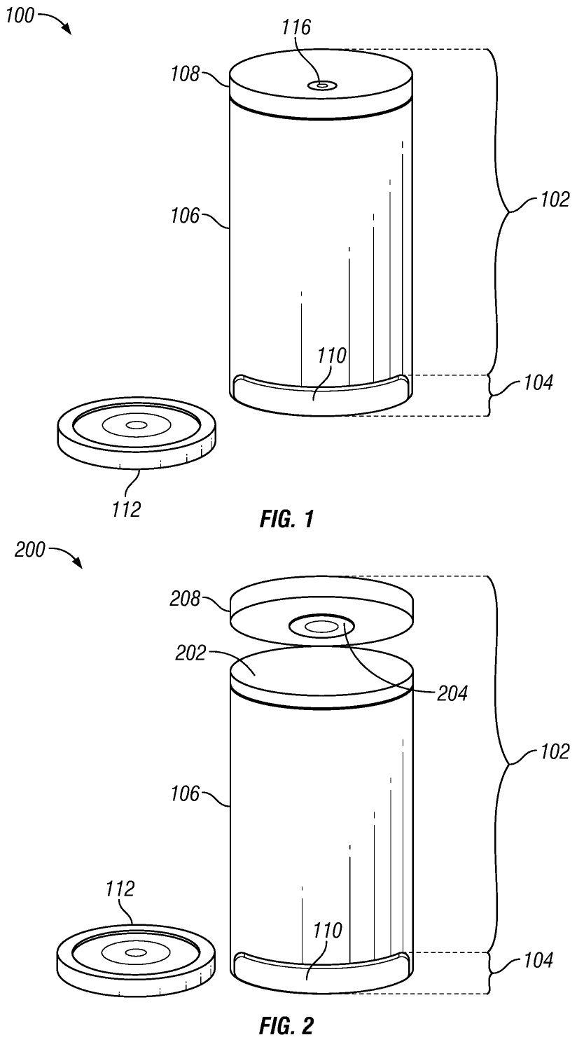

Referring to FIG. 1, according to certain non-exclusive embodiments, a system 100 includes a housing 102. The housing 102 connects to a base 104, either fixedly or removably according to implementation. The housing 102 has extending wall 106. The housing 102 and wall 106 are enclosed by a lid 108. The base 104 is formed with an inlet 110 sized to accommodate a robotic vacuum 112. The housing 102 and wall 106 form a trash receptacle/can, closed by the lid 108. The inlet 110 of the base 104 is a docking station for the robotic vacuum 112, and may include therewith electrical charging contacts 114 (not shown) for electrically contacting the robotic vacuum 112.

In operation, the lid 108 is opened to allow access to inside the housing 102 for receiving trash deposited therein and disposing of trash contained therein. If the housing 102 is removable from the base 104, trash may be disposed by lifting the housing 102 from connection to the base 104. If the housing 102 is fixed to the base 104, the entire system 100 is lifted when disposing of trash.

The base 104, when located on a floor or surface, is connected to an electric outlet or other source of power. The robotic vacuum 112 is programmed to transit to the inlet 110 of the base 104 when charging of the robotic vacuum 112 is warranted or desired. The robotic vacuum 112 enters the inlet 110 and, when settled therein, electrically connects to the charging contacts 114.

In various alternative embodiments, the lid 108 may be automated and/or manually opened and closed for operation of the trash can/receptacle. For non-exclusive example, an eye or sensor 116 may operate on movement or other action in vicinity, in order to open and/or close the lid 108. Also in alternatives, the contacts 114 may or may not be wired or wireless charge device for charging the robotic vacuum 112. In other alternatives, the robotic vacuum 112 may be manually or automatically emptied of collected dirt and other items, such as when the robotic vacuum 112 approaches but does not enter the inlet 110 or when the robotic vacuum 112 lodges in the inlet 110. For non-exclusive example, a collection in a canister, feed to the trash can, or other disposition of debris can be possible, if vacuumed by the system 100 or output by the robotic vacuum 112 of otherwise where so equipped in accordance with certain embodiments.

Referring to FIG. 2, according to certain non-exclusive embodiments, a system 200 includes an alternative lid 208 containing an outlet 204 connected to the inside 202 of the housing 102 defined by the walls 106. The outlet 204 exhausts debris into the inside 202 as will be later detailed. The system 200 includes the base 104 forming the inlet 110 for receiving the robotic vacuum 112.

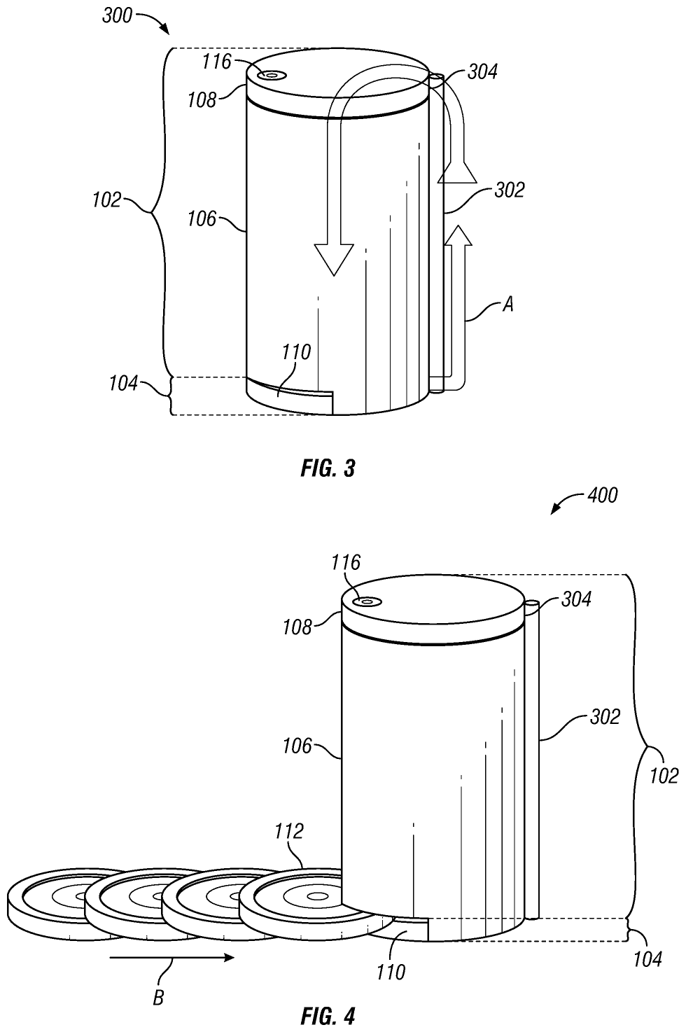

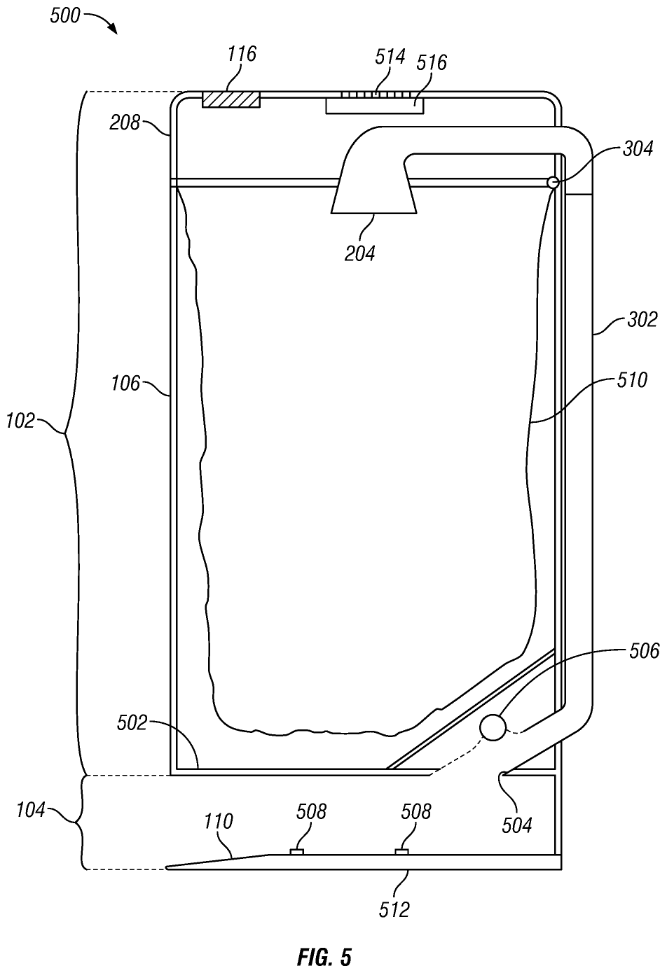

Referring to FIG. 3, in conjunction with FIG. 2, according to certain non-exclusive embodiments, a system 300 includes the housing 102 and the base 104. The system 300 also includes a duct 302 extending from about the base 104 to an open (upper) end of the housing 102 at the lid 108. The lid 108 is connected to a hinge 304 connected to periphery at the open (upper) end of the wall 106 of the housing 102. The duct 302 is communicatively connected to an opening (shown in FIGS. 5 and/or 6) at, near or within the inlet 110 in vicinity of a vacuumed debris dispenser/emptier location of the robotic vacuum 112, and to the outlet 204 into the inside of the trash can/receptacle of the housing 102 defined by the walls 106 and/or into a separate canister of the housing 102, as applicable in the implementation.

In operation, the robotic vacuum 112 transits to the inlet 110 for docking (and possibly charging) and/or to empty vacuumed debris contained in the robotic vacuum 112. When located in the inlet 110, the robotic vacuum 112 is emptied of debris via the duct 302, such as by vacuum motor communicatively connected to the duct 302 or otherwise. Arrow “A” generally indicates a possible circulation of debris emptied from the robotic vacuum 112 via the duct 302 and into the trash can/receptacle of the housing 102 from the outlet 204.

Referring to FIG. 4, in conjunction with FIGS. 2 and 3, according to certain non-exclusive embodiments, a system 400 includes the housing 102 and the base 104. The robotic vacuum 112 is shown in transit by arrow “B” to the inlet 110. The duct 302, via suction of vacuum motor or similar, empties the contained vacuum debris from the robotic vacuum 112.

Referring to FIG. 5, according to certain non-exclusive embodiments, a system 500 includes the housing 102 connected (fixedly, removably, or otherwise) to the base 104. The housing 102 is formed of the wall 106 and the bottom 502 and is open at the top and closed by the lid 208. The lid 208 is connected to the wall 106 of the housing 102 by the hinge 304. The lid 208 includes the sensor 116 in certain non-exclusive embodiments in which the lid 208 automatically operates.

The base 104 includes the inlet 110. The inlet 110 may include a deck, slot or other structure 512 on or in which the robotic vacuum 112 (not shown) positions for docking. Charging elements 508 may be connected to the inlet 110, such as on the structure 512 or otherwise, to chargingly connect to counterpart elements of the robotic vacuum 112. The inlet 110 also forms, includes and/or connects to a suction inlet 504. The suction inlet 504 is connected to the duct 302. The duct 302 is connected to the outlet 204 of the lid 208. The duct 302 can include a flex to allow the lid 208 to open and close with the outlet 204 and lid 208.

A vacuum motor 506 is communicatively connected to the duct 302. The vacuum motor 506 is operable to via suction unload collected debris from the robotic vacuum 112 when positioned in the inlet 110. In the non-exclusive example of the embodiment, the robotic vacuum is unloaded from atop the vacuum 112, such as through a hole, vent or otherwise as applicable for the vacuum 112, through the suction inlet 504 and into and through the duct 302 out the outlet 204. The lid 208 includes an exhaust vent 514 for exit of exhaust from the vacuum 506. The vacuum motor 506 circulates the unloaded debris through the duct 302 and out the outlet 204 into the housing 102. In non-exclusive embodiments, a trash liner 510, such as a garbage bag, a bucket, or otherwise, can retain debris from unloading of the robotic vacuum 112 as well as other trash and debris placed in the housing 102 through the lid 208 when opened.

In operation, the system operates as a trash can to retain trash and other debris. The lid 208 is opened and shut, either manually, mechanically, automatically via sensor, and/or otherwise, to deposit, contain and empty the trash and debris. The system may, according to certain nonexclusive embodiments, also operate as a charging station for the robotic vacuum. The robotic vacuum contacts the inlet or other feature of the system and electrically or otherwise chargingly connects to docking (and if applicable, charging) elements of the system.

The robotic vacuum operates by traversing a programmed track to vacuum debris. The system retrieves, via vacuum motor operation, collected debris from the robotic vacuum. The debris retrieved by the system via vacuum passes into the suction inlet, travels (upward or as otherwise implemented) along the duct, and is dispersed out the outlet and into the trash can/receptacle of the housing. The system operates to retrieve the debris from the robotic vacuum when the robotic vacuum is positioned in the inlet of the base and at times or sequence as programmed for the system. For non-exclusive example, the robotic vacuum may be emptied by the system when the robotic vacuum filled with vacuumed debris returns to the base for such purpose of emptying, at programmed times, at any time the robotic vacuum returns to the base, and/or otherwise, and combinations of these.

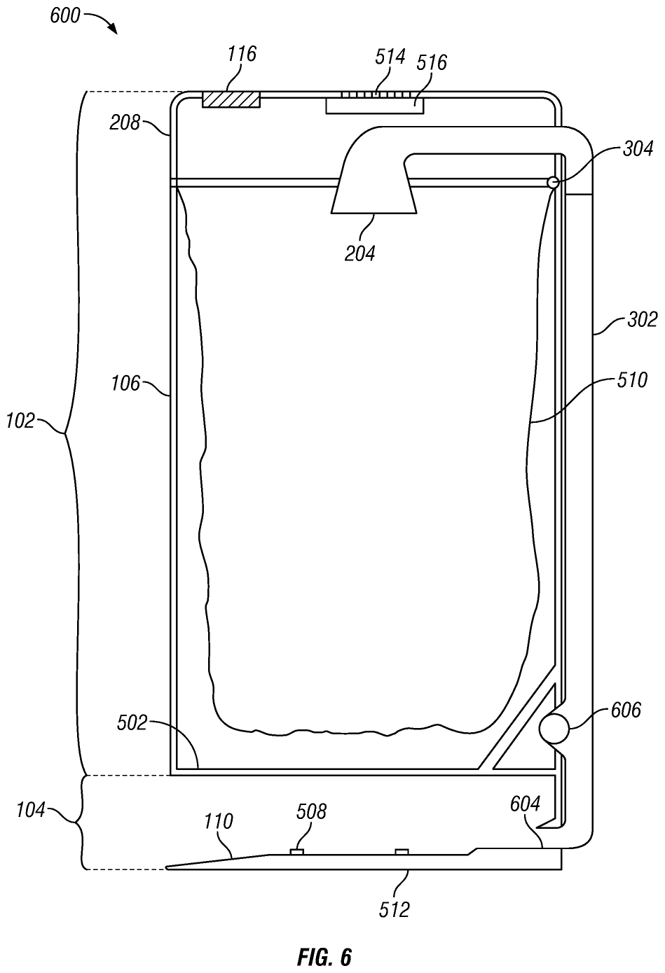

Referring to FIG. 6, according to certain non-exclusive embodiments, another system 600 includes the housing 102 connected (fixedly, removably, or otherwise) to the base 104. The housing 102 is formed of the wall 106 and the bottom 602 and is open at the top and closed by the lid 208. The lid 208 is connected to the wall 106 of the housing 102 by the hinge 304. The lid 208 includes the sensor 116 in certain non-exclusive embodiments in which the lid 208 automatically operates.

The base 104 includes the inlet 110. The inlet 110 may include a deck, slot or other structure 512 on or in which the robotic vacuum 112 (not shown) positions for docking. The docking may or may not, as applicable, include charging elements 508 connected to the inlet 110, such as on the structure 512 or otherwise, to chargingly connect to counterpart elements of the robotic vacuum 112. The inlet 110 also forms, includes and/or connects to a suction inlet 604. The suction inlet 604 is positioned in or adjacent the structure 512, or at an extent thereof, or otherwise according to the implementation for the particular robotic vacuum 112 and its emptying configurations. The suction inlet 604 is connected to the duct 302. The duct 302 is connected to the outlet 204 of the lid 208. The duct 302 can include a flex to allow the lid 208 to open and close with the outlet 204 and lid 208.

A vacuum motor 606 is communicatively connected to the duct 302. The vacuum motor 606 suctions to unload collected debris from the robotic vacuum 112 positioned in the inlet 110 with an emptying portal of the robotic vacuum 112. In the non-exclusive example of the embodiment, the robotic vacuum 112 is unloaded from underside of the vacuum 112, such as through a hole, vent or otherwise as applicable for the vacuum 112. The vacuumed debris from the robotic vacuum 112 is vacuumed by the system 600 through the suction inlet 604, into and through the duct 302, and out the outlet 204. The lid 208 includes an exhaust vent 514 for exit of exhaust from the vacuum motor 606. The vacuum motor 606 circulates the unloaded debris through the duct 302 and out the outlet 204 into the housing 102. A trash liner 510, such as a garbage bag, a bucket, or otherwise, according to non-exclusive embodiments, can retain debris from unloading of the robotic vacuum 112. The liner 510 can also retain trash and debris placed in the housing 102 through the lid 208 when opened.

In operation, the system operates as a trash can to retain trash and other debris. The lid is opened and shut, either manually, mechanically, automatically via sensor, and/or otherwise, to deposit, contain and empty the trash and debris. The system also may operate as a charging station for the robotic vacuum. The robotic vacuum contacts the inlet or other feature of the system and electrically or otherwise chargingly connects to charging elements of the system.

The robotic vacuum operates by traversing a programmed track to vacuum debris. The system retrieves, via vacuum motor operation, collected debris from the robotic vacuum. The debris retrieved by the system via vacuum passes into the suction inlet, travels (upward or as otherwise implemented) along the duct, and is dispersed out the outlet and into the trash can/receptacle of the housing. The system operates to retrieve the debris from the robotic vacuum when the robotic vacuum is positioned in the inlet of the base and at times or sequence as programmed for the system. For non-exclusive example, the robotic vacuum may be emptied by the system when the robotic vacuum filled with vacuumed debris returns to the base for such purpose of emptying, at programmed times, at any time the robotic vacuum returns to the base, and/or otherwise, and combinations of these.

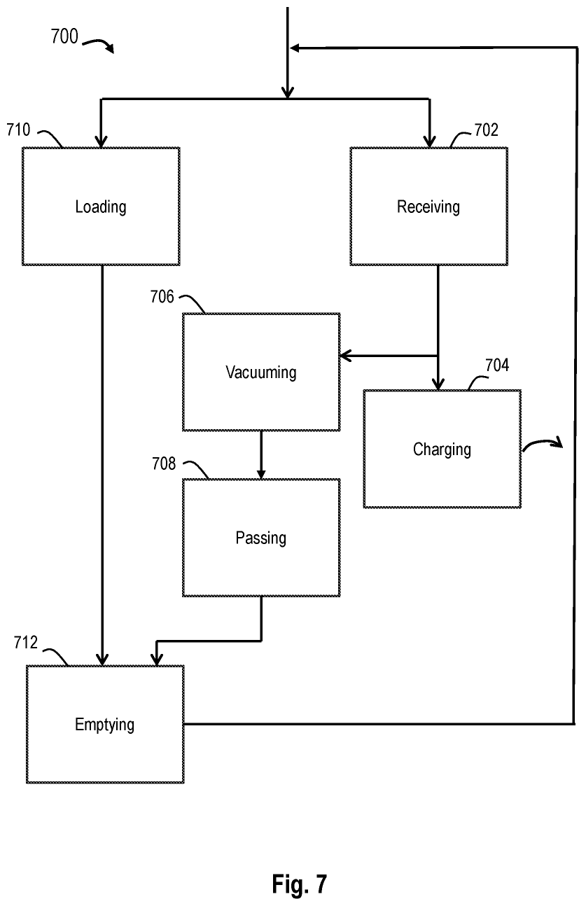

Referring to FIG. 7, a method 700 of operation of a combination trash can and charging station for a robotic vacuum includes receiving 702 the robotic vacuum in an inlet of the docking station of the trash can. When positioned in the docking station, the robotic vacuum may be charged 704 or not, depending on programming and configuration. Concurrently, sequentially or otherwise to charging 704 and when a lid of the trash can is closed, a vacuum motor of the trash can/docking station vacuums 706 collected debris from the robotic vacuum. The vacuumed debris passes 708 into the trash can. At other times from the vacuuming 706, the lid of the trash can may be opened for loading 710 the trash can with refuse. The method 700 may further include emptying 712 the trash can.

Various alternatives are possible including that the trash can includes a charging station for the robotic vacuum and either does or doesn't include a vacuum motor for retrieving collected debris from the vacuum. Other configurations are possible, for non-exclusive example, suction inlet(s) can be variously located in the base or other orientation of the trash can. Vacuuming debris from the robotic vacuum by the trash can may be automated, programmed, or manual, or otherwise or combinations. Configuration of the base docking station of the trash can be widely varied, with other programming or implementation options and/or charging elements, as applicable. Positioning of suction inlet(s), vacuum motor, duct, and other elements may be varied. Further, the base may be incorporated in the trash can, fixedly or removably connected to the trash can, or oriented in different arrangements (for non-exclusive example, side by side or otherwise).

As will be understood, wide variation is possible in the foregoing embodiments. Although elements or units may be illustrated as standalone and unitary, the elements or units may alternately be comprised of more than one piece or part as desired in the implementation. Variation is also possible in the operations. Although certain operations and programming are disclosed, numerous other steps, operations, processes and methods may be implemented in the systems.

In the foregoing, the invention has been described with reference to specific embodiments. One of ordinary skill in the art will appreciate, however, that various modifications, substitutions, deletions, and additions can be made without departing from the scope of the invention. Accordingly, the specification and figures are to be regarded in an illustrative rather than a restrictive sense, and all such modifications substitutions, deletions, and additions are intended to be included within the scope of the invention. Any benefits, advantages, or solutions to problems that may have been described above with regard to specific embodiments, as well as device(s), connection(s), step(s) and element(s) that may cause any benefit, advantage, or solution to occur or become more pronounced, are not to be construed as a critical, required, or essential feature or element.

What is claimed is:

1. A system, comprising:
a trash can;
a robotic vacuum docking station connected to the trash can.

2. A system, comprising:
a trash can with an upper lip;
a hinge connected to the upper lip of the trash can;
a lid connected to the hinge for enclosing the trash can when the lid is closed on the hinge;
an inlet connected to the trash can for receiving a robotic vacuum; and
a docking element of the inlet for contacting the robotic vacuum received in the inlet.

3. A system, comprising:
a trash can;
a robotic vacuum docketing station connected to the trash can; and
a vacuum of the trash can for retrieving vacuumed debris from the robotic vacuum and emptying the vacuumed debris into the trash can.

4. A system, comprising:
a trash can with an upper lip;
a hinge connected to the upper lip of the trash can;
a lid connected to the hinge for enclosing the trash can when the lid is closed on the hinge;
an inlet connected to the trash can for receiving a robotic vacuum;
a docking element of the inlet for contacting the robotic vacuum received in the inlet;
a suction inlet of the inlet;
a vacuum motor connected to the suction inlet;
a duct connected to the vacuum motor; and
an outlet connected to the duct, the outlet dispenses vacuumed debris collected by the robotic vacuum into the trash can.

5. A system, comprising:
a trash can;
a robotic vacuum docking station connected to the trash can; and
a vacuum communicatively connected to a collected debris accessway of the robotic vacuum.

6. The system of claim 5, further comprising:
a canister connected to the vacuum;
wherein the vacuum retrieves the collected debris from the robotic vacuum and contains the collected debris so retrieved in the canister.

7. A method, comprising:
receiving a robotic vacuum in a combined docking station and trash can; and
charging the robotic vacuum from receiving.

8. The method of claim 7, further comprising:
loading a trash into the trash can of the combined docking station and trash can.

9. The method of claim 8, further comprising:
emptying the trash from the trash can.

10. The method of claim 8, further comprising:
vacuuming collected debris from the robotic vacuum by the trash can.

11. The method of claim 8, further comprising:
passing collected debris from the robotic vacuum into the trash can.

12. A method of manufacture, comprising:
providing a trash can;
connecting a robotic vacuum docking station to the trash can.

13. The method of manufacture of claim 12, further comprising:
providing a vacuum motor to the trash can, the vacuum motor communicatively connects to a collected debris of a robotic vacuum when the robotic vacuum is positioned in the robotic vacuum docking station;
providing a duct connected to the vacuum motor, the duct channels the collected debris into a collection chamber.

14. The method of manufacture of claim 13, wherein the collection chamber is the trash can.

15. The system of claim 1, wherein the docking station is a charging station.

16. The system of claim 2, wherein the docking element is a charger.

17. The system of claim 3, wherein the docketing station is a charger for the robotic vacuum.

18. The system of claim 4, wherein the docking element includes a charger for the robotic vacuum.

19. The system of claim 5, wherein the robotic vacuum docking station is a charging station.

20. The method of claim 7, wherein the docking station is a charger for the robotic vacuum.

21. The method of claim 12, further comprising:
providing the robotic vacuum docking station with a charger for the robotic vacuum.
